(19) United States
(12) Patent Application Publication
(10) Pub. No.: US 2016/0002081 A1
(43) Pub. Date: Jan. 7, 2016

(54) WASTEWATER TREATMENT WITH MEMBRANE AERATED BIOFILM AND ANAEROBIC DIGESTER

(71) Applicant: GENERAL ELECTRIC COMPANY, Schenectady, NY (US)

(72) Inventor: Pierre Lucien COTE, Dundas (CA)

(21) Appl. No.: 14/769,372

(22) PCT Filed: Feb. 22, 2013
(86) PCT No.: PCT/US2013/027411

§ 371 Date: Aug. 20, 2015

(51) Int. Cl. C02F 3/30; C02F 11/02

(52) U.S. Cl. CPC C02F 3/30; C02F 11/02

(57) ABSTRACT

A wastewater treatment system having a first solid-liquid separation unit, a membrane aerated biofilm (MABR) reactor, a second solid-liquid separation unit and an anaerobic digester. Waste sludges from the solid-liquid separation units are treated in the anaerobic digester. The solid-liquid separation unit preferable comprises a micro-sieve. The treatment system may also comprise an aerated contact tank with a hydraulic retention time of 6 hours or less. Optionally, the MABR may comprise a membrane filtration unit.

### FIELD OF THE INVENTION

Embodiments of the present invention relate to wastewater treatment.

### BACKGROUND

A conventional activated sludge wastewater treatment system has a primary clarifier followed by one or more tanks in which mixed liquor is maintained under aerobic, anoxic or anaerobic conditions by modifying the amount of air bubbled into the tanks. Mixed liquor leaving these tanks is treated in a second clarifier or with a membrane to produce an effluent and activated sludge. Some of the activated sludge is returned to the process tanks. In some plants, the remainder of the activated sludge is thickened and then sent to an anaerobic digester with sludge from the primary clarifier.

### SUMMARY OF THE INVENTION

A wastewater treatment system is described in this specification having a first solid-liquid separation unit, a membrane aerated biofilm (MABR) reactor and an anaerobic digester. Influent, for example screened and degritted municipal sewage, flows through the first solid-liquid separation unit to the MABR. Sludges from the first solid-liquid separation unit and the MABR flow to the anaerobic digester. In an embodiment, the MABR is a hybrid reactor which comprises a membrane-supported biofilm and suspended biomass in a tank followed by a solid-liquid separation unit with sludge recycle. In an embodiment, the first solid-liquid separation unit is a micro-sieve. The wastewater treatment system may also comprise an aeration tank.

A wastewater treatment process is described in this specification in which wastewater is treated to produce a first sludge and a first effluent. The first effluent is contacted with membrane aerated biofilms and separated to produce a second sludge and a second effluent. Optionally, this separation step may comprise membrane filtration. Waste portions of the first sludge and the second sludge are treated by way of anaerobic digestion. The waste portions of the first sludge and the second sludge divert significant portions of the total suspended solids and chemical oxygen demand of the wastewater to the anaerobic digester.

### BRIEF DESCRIPTION OF THE FIGURES

FIG. 1 is a process flow diagram of a first wastewater treatment system.

FIG. 2 is a process flow diagram of a second wastewater treatment system.

FIG. 3 is a process flow diagram of a third wastewater treatment system.

### DETAILED DESCRIPTION

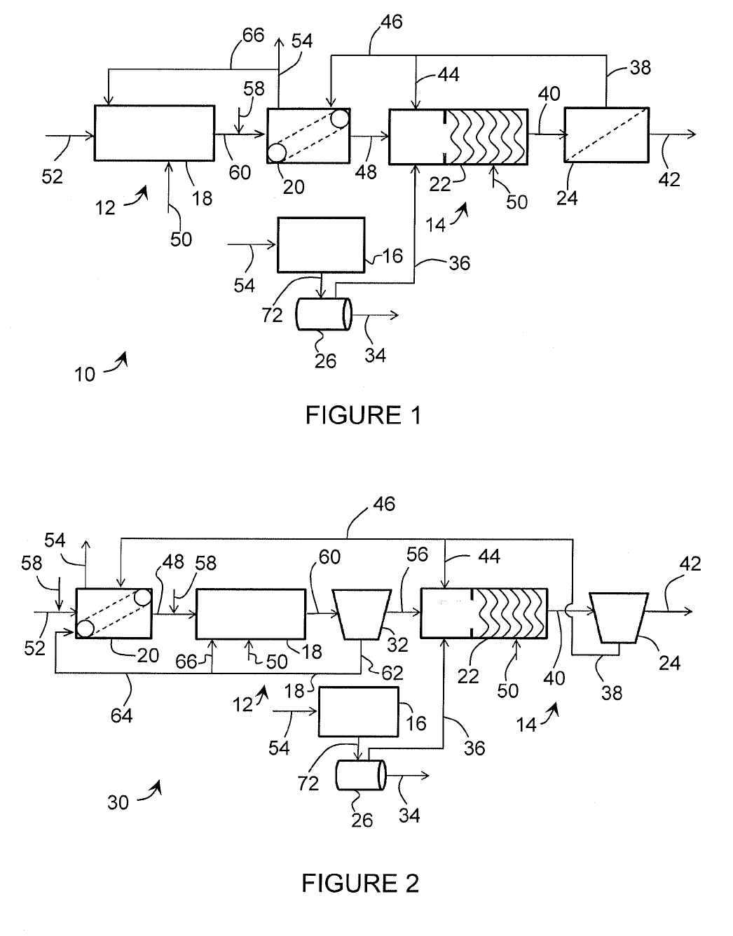

FIG. 1 shows a wastewater treatment system 10. The system 10 has an upstream treatment unit 12, a membrane aerated biofilm reactor (MABR) 14, and an anaerobic digester 16. The upstream treatment unit 12 has an aeration tank 18 followed by a first solid-liquid separation device 20. MABR 14 has a process tank 22 followed by a second solid-liquid separation device 24. Optionally, the system 10 may also have a sludge dewatering unit 26.

FIG. 2 shows a second wastewater treatment system 30. The second system 30 has the components listed above for the system 10 as well as a third solid-liquid separation device 32 in the upstream treatment unit 12. However, unlike the system 10, the first solid-liquid separation device 20 is upstream of the aeration tank 18. The third solid-liquid separation device 32 is downstream of the aeration tank 18 but upstream of the MABR 14.

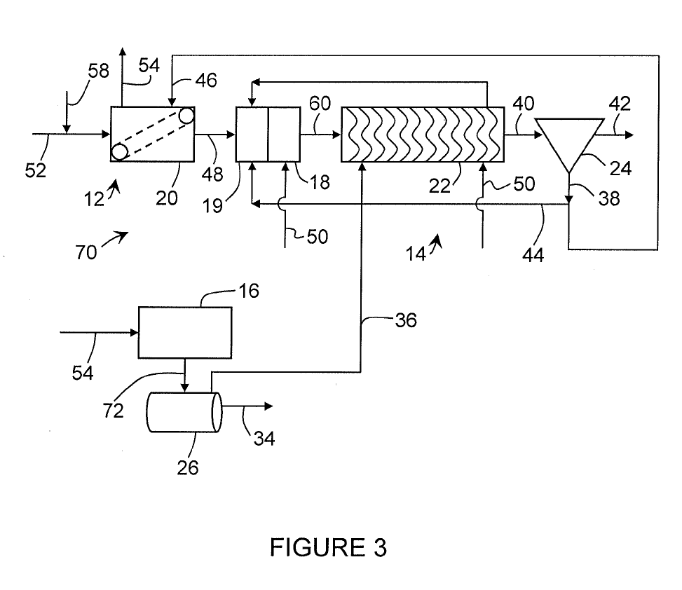

FIG. 3 shows a third wastewater treatment system 70. The third wastewater treatment system 70 has the components listed above for the system 10 as well as, optionally, an anoxic tank 19. However, unlike the system 10, the first solid-liquid separation device 20 is upstream of the aeration tank 18. Unlike the second system 30, there is no third solid-liquid separation device 32. However, as will be described further below, the second-solid liquid separation device 24 in the MABR 14 cooperates with the aeration tank 18 and can be considered to be also part of the upstream treatment unit 12. Alternatively or additionally, the aeration tank 18 and any anoxic tank 19 may be considered as part of the MABR 14.

Suitable conduits, inlets and outlets allow for the flow of liquids to, from and within the systems 10, 30, 70. Influent 52 may be municipal sewage or another type of raw wastewater. In an embodiment, the influent 52 passes through one or more pre-treatment steps (not shown) before entering the system 10, 30, 70 as pre-treated wastewater. For example, the influent 52 may be screened or de-gritted or both. Screening may be done with a coarse screen, for example with openings in the range of 3 to 6 mm. De-gritting may be done, for example, in a vortex unit.

In an embodiment, the first solid-liquid separation unit 20 is a micro-sieve, alternatively referred to as a micro-screen or a micro-strainer. A micro-sieve operates by using well defined apertures, typically in a sheet form material, to block particles. The material may be in the form of an endless belt, a rotating drum, or rotating discs. The apertures typically have a size in the range from 10-1000 microns, or 50-350 microns, measured as the diameter of a circle of equivalent area for non-circular openings. Commercial examples include rotating belt sieves by Salsnes or M2R, rotating disc filters by Estuagua and rotating drum filters by Passavant Geiger.

The type of device used for the second solid-liquid separation unit 24 is not critical. Although FIG. 1 shows the second solid liquid separation device 24 as a membrane filter whiles FIGS. 2 and 3 show a gravity settler, either type of device, or another suitable solid-liquid separation device, may be used in any of the systems 10, 30, 70.

The type of device used for the third solid-liquid separation unit 32 is also not critical. In the second system 30 as shown in FIG. 2, the third solid-liquid separation unit 32 is a gravity settler.

The first solid-liquid separation unit 20 produces a waste sludge 54 and a sieved influent 48. The waste sludge 54 is treated in the anaerobic digester 16. The sieved influent 48 is treated in any remainder of the upstream treatment unit 12 or the MABR 14. The first solid-liquid separation unit 20 may also treat waste sludge from the second solid-liquid separation device 24 or any third solid-liquid separation device 32 or both. Alternatively, one or more of these waste sludges may be sent directly, or through another thickener, to the anaerobic digester 16.

A micro-sieve, when used as the first solid-liquid separation device 20, removes a substantial amount of particulate and colloidal chemical oxygen demand (COD) to the anaerobic digester 16. In an embodiment, the micro-sieve removes at least 50%, for example 50-80%, of the total suspended solids (TSS) in water flowing into it to the anaerobic digester 16. In an embodiment, the micro-sieve also removes at least 40%, for example 40-80%, of the COD or biological oxygen demand (BOD) of the water flowing into it to the anaerobic digester 16. This increases the amount of COD that is digested anaerobically relative to a conventional activated sludge process. Diverting COD to the anaerobic digester 16 decreases the energy consumption of the wastewater treatment process. A micro-sieve also functions to remove trash and fibers that might otherwise interfere with downstream membranes, either gas transfer membranes or filtering membranes.

In an embodiment, a type of micro-sieve is a rotating belt sieve (RBS). Suitable RBS units are available, for example, from Salsnes or M2R. The RBS may be equipped with an auger downstream of a screening surface but ahead of a sludge outlet. The auger allows concentrating sludge to a TSS concentration of 10% or more or 15% or more. Waste sludge at a TSS concentration of 10% or more and can be fed directly into an anaerobic digester 16 without pre-thickening.

A coagulant 58 may be added to the influent to the first solid-liquid separation device 20. The coagulant 58, for example a polymer, alum or ferric chloride, helps remove COD as well as phosphorus from the influent 52 particularly when a micro-sieve is used. A coagulant 58 may also be added in the MABR 14 upstream of the second solid-liquid separation unit 24 to polish the effluent 42, for example to remove residual phosphorous.

The aeration tank 18 of the systems 10, 30, 70 receives influent 52 or sieved influent 48 and at least one form of returned sludge. In the first system 10, a primary return sludge 66 is extracted from the waste sludge 54 and sent to the aeration tank 18. In the second system 30, a primary return sludge 66 is extracted from a primary sludge 62 produced by the third solid-liquid separation device 32. The primary return sludge 66 is sent to the aeration tank 18 while the remaining primary waste sludge 64 is sent to the first solid-liquid separation unit 20. In the third system 70, the aeration tank 18 receives return activate sludge 44 extracted from activated sludge 38. Remaining waste activated sludge 46 is sent to the first solid-liquid separation unit 20. Optionally, the primary return sludge 66 or return activated sludge 44 may be aerated in a second aeration tank or zone of the aeration tank 18 that does not receive influent 52 or sieved influent 48 before flowing to the aeration tank 18.

In an embodiment, the aeration tank 18 has a hydraulic retention time (HRT) of 6 hours or less, for example in the range of 0.2 to 3 hours. The sludge retention time (SRT), alternatively called solids retention time, of the aeration tank 18 is 6 days or less in an embodiment, or 3 days or less in an embodiment. In the third system 70, the combination of the aeration tank 18 and the anoxic tank 19 according to an embodiment has an HRT of 6 hours or less, for example in the range of 0.2 to 3 hours, and an SRT of 6 days or less, or 3 days or less.

Air 50 is added to the aeration tank 18 of the upstream treatment unit 12. In the aeration tank, colloidal organic matter from the influent 52 or sieved influent 48 attaches to biological floc provided by the sludge recycle. The aeration tank 18 may thereby function as a solids contact aeration unit, a short SRT activated sludge reactor or a contact stabilisation unit. The influent 52 or sieved influent 48 may be treated by solids contact aeration or contact stabilisation.

In the first and second systems 10, 30, aeration tank effluent 60 is treated by a solid-liquid separation unit 20, 32 located directly after the aeration tank 18. Sludge from this adjacent solid-liquid separation unit 20, 32 provides primary return sludge 66 for recycle to the aeration tank 18. In the third system 70, aeration tank effluent 60 is fed to the process tank 22 of the MABR 14. Floc in the aeration tank effluent 60 is generally not digested in the process tank 22 because there is insignificant oxidation of the mixed liquor. However, the floc is removed in the second solid-liquid separation unit 24. The MABR 14 thereby functions as a replacement for an adjacent solid-liquid separation unit and the secondary return sludge 44 replaces the primary return sludge recycle to the aeration tank 18.

The sieved effluent 48, a primary effluent 56, or aeration tank effluent 60 is treated further in the MABR 14. The MABR 14 comprises one or more gas transfer membrane modules immersed in the process tank 22. The membrane modules receive air 50 and are adapted for aerating a biofilm that, in use, becomes attached to the membrane surfaces. In use, the process tank 22 has both a membrane-aerated biofilm and suspended biomass according to an embodiment. The upstream treatment unit 12 removes a significant amount of carbon but other nutrients such as nitrogen are primarily removed in the MABR 14 due to the short SRT of the aeration tank 18. Nitrogen is removed in the MABR 14 by way of nitrification-denitrification process performed by bacteria present in the membrane attached biofilm and, in an embodiment, suspended growth bacteria. While in theory a single membrane aerated biofilm can provide both nitrification and de-nitrification, it can be easier to control an MABR with suspended anaerobic biomass since in that case it is only necessary for the biofilm to support nitrifying bacteria. Some remaining suspended solids and COD are also removed in the MABR 14.

In the MABR 14, a gas, such as oxygen or air, is transported through the membrane directly to the membrane supported biofilm without the creation of bubbles. This method significantly reduces the energy required for gas transfer. Membrane biofilm reactors were recently reviewed by Martin and Nerenberg in “The membrane biofilm reactor (MBfR) for water and wastewater treatment: Principles, applications, and recent developments” (Bioresour. Technol. 2012). MABRs were reviewed by Syron and Casey in “Membrane-Aerated Biofilms for High Rate Biotreatment: Performance Appraisal, Engineering Principles, Scale-up, and Development Requirements” (Environmental Science and Technology, 42(6): 1833-1844, 2008). U.S. Pat. Nos. 7,169,295 and 7,294,259 describe MABRs and methods of operating them and are incorporated by reference. In examples, membranes are made from dense wall poly methyl pentene (PMP) hollow fiber membranes used in tows or formed into a fabric. The membranes are potted in modules to enable oxygen containing gas to be supplied to the lumens of the hollow fibers through a header. A biofilm grows on the outside of the fibers.

The MABR 14 may be a plug flow reactor, a continuously stirred tank reactor (CSTR), or comprise multiple CSTRs in series. Modules comprising oxygen transfer membranes are immersed in one or more process tanks 22. The modules are fed with oxygen or an oxygen containing gas such as air 50. Oxygen passes through the membrane wall to the attached biofilm. Aerobic reactions take place near the surface of the membranes. These reactions include converting organic carbon compounds to carbon dioxide and water and converting ammonia to nitrite and nitrate. In an embodiment, the surface of the biofilm is maintained under anoxic conditions by limiting the amount of oxygen transferred such that conversion of nitrate to nitrogen can take place by denitrification by the external layers of the biofilm, in suspended biomass, or both. The mixed liquor outside of the biofilm, which contains suspended bacteria growth in an embodiment, is anoxic. The result is simultaneous reduction of organic carbon, ammonia and total nitrogen. In cases where the MABR 14 has sludge recycle to the process tank 22 and the process tank 22 contains suspended biomass in use, the MABR 14 may be called a hybrid reactor.

In an embodiment, air 50 is provided to the membranes by flow through the membranes to an exhaust. In a flow through mode of operation, some nitrogen may also be removed as ammonia in the exhaust gas. The thickness of the biofilm is controlled, for example by periodic coarse bubble scouring or mechanical mixers. Coarse bubbles or mechanical mixers can also be used continuously or intermittently to mix the process tank 22. Coarse bubbles can be made from air or from exhaust from the membrane modules.

Mixed liquor 40 leaving the process tank 22 is separated into activated sludge 38 and the plant effluent 42. The plant effluent 42 may be discharged or re-used, optionally after further polishing steps. Activated sludge 38 is divided into a return activated sludge 44 and a waste activated sludge 46. Return activated sludge 44 is recycled to the process tank 22 directly or, in the third system 70, to through the aerobic tank 18 and optionally also through the anoxic tank 19.

Optionally, mixed liquor 40 may also be recycled to the upstream end of the process tank 22 or, in the third system 70, to the anoxic tank 19 or aerobic tank 18. If the process tank 22 is not completely mixed, the mixed liquor 40 at the downstream end of the process tank 22 has less ammonia and more nitrate than mixed liquor at the upstream end of the process tank 22. Recycling the mixed liquor 40 can help improve total nitrogen removal. In the third system 70, the mixed liquor 40 also provides some of the oxygen used in the anoxic tank 19 or aerobic tank 18. In the third system 70, only one of the mixed liquor 40 and return activated sludge 44 is required to be recycled to the anoxic tank 19 or aerobic tank 18. The other of these two streams may also be recycled to the anoxic tank 19 or aerobic tank 18 or it may be recycled only to the upstream end of the process tank 22.

Waste activated sludge 46 is sent to the anaerobic digester 16. Waste activated sludge 46 can flow directly or through the first solid-liquid separation device 20 to the digester 16. In the system 10, the second solid-liquid separation device 24 according to an embodiment is an ultrafiltration or microfiltration membrane system but a gravity settler may be used. In the second system 30, the second solid-liquid separation device 24 according to an embodiment is a gravity settler but a membrane filtration system may be used. In the third system 70, the second solid-liquid separation device 24 may be a gravity settler or membrane filtration system.

The MABR 14 provides biological nitrogen removal from the remainder of the influent 52 that passes through the upstream treatment unit 12. Since the upstream treatment unit removes suspended and some colloidal matter, contaminants in the remainder of the influent 52 are primarily soluble. The membrane aerated biofilm of the MABR 14 has an aerobic zone and nitrifies the remainder of the influent 52. The mixed liquor in the MABR 14 includes an anoxic zone and provides denitrification and some further COD removal. In an embodiment, oxygen is provided in the MABR 14 essentially through the membrane aerated biofilm. Any coarse bubble aeration for biofilm control or mixing provides minimal oxygen transfer and can be deemed not to provide oxygen to the MABR 14.

The anaerobic digester 16 may comprise, for example, one or more covered mixed tanks. In an embodiment, digester sludge 72 from the anaerobic digester 16 is dewatered in the sludge dewatering unit 26 to produce dewatered sludge 34. The dewatered sludge 34 may be disposed of or treated further. The sludge dewatering unit 26 may be, for example, a centrifuge, screw thickener or filter press. A digester sludge liquid portion 36 is rich in COD and ammonia and may be sent to the MABR 14 for further treatment and to provide a further carbon source for the MABR 14.

In the systems 10, 30, 70, suspended solids (SS) and COD may be diverted from the influent 52 to the anaerobic digester 16 by the upstream treatment unit 12 for example using a micro-sieve, such as a rotating belt sieve (RBS) with an outlet auger. In the system 10, the micro-sieve is used downstream of the aeration tank 18 and integrated with a recycle loop involving the aeration tank 18. In this way, floc with attached colloidal matter is removed in the micro-sieve. In the second system 30, the micros-sieve is the first unit process after pre-treatment and is followed by the aeration tank 18 which may operate to some extent as part of a solids contact aeration device with floc removed in another solid-liquid separation unit. In the third system 70, the micro-sieve is also the first unit process after pre-treatment. A downstream aeration tank 18 operates as part of a solids contact device with floc removed in the MABR 14, in particular in the second solid-liquid separation unit 24.

Overall, systems 10, 30, 70 are likely to be more energy efficient than a conventional activated sludge process. This is because a greater amount of COD is diverted to anaerobic digestion, because the membrane module in the MABR 14 can supply most of the air needed for aerobic treatment while using less energy than bubbling, or both. The MABR 14 can remove nitrogen without the addition of an external source of carbon since soluble COD in effluent from the upstream treatment unit 12, and optionally from the anaerobic digester 16, is available for denitrification.

A mass and energy balance calculated for designs for a typical 5 MGD (18,925 m3/d) plant are presented in Tables 1 to 4. The oxygen requirement for the systems 10, 30, 70 is 33% lower than a conventional activated sludge membrane bioreactor (MBR) primarily because a larger portion of the COD is diverted to anaerobic digestion (Table 1). Biogas produced in the anaerobic digester is assumed to be converted into electricity in a combined heat and power (CHP) unit comprising, for example, a biogas fired engine driving an electrical generator. The amount of sludge converted to electricity is 16% greater in the systems 10, 30, 70 based on the assumption that 35% of the energy value of biogas is converted to electricity in the CHP unit (Table 2). The electrical energy demand for all unit processes is less for the systems 10, 30, 70 when compared to a conventional MBR. The key benefit of the MABR is its ability to transfer oxygen efficiently. MABRs typically transfer 5-15 kg O₂/kWh (8 kg O₂/kWh) in comparison to 1-2 kg O₂/kWh for air bubbling systems. The net total electrical energy consumption for the systems 10, 30, 70 is lower than for the conventional MBR. With the third system 70, a small amount of net energy production appears possible. Theses energy balances does not take into account useable heat produced by the CHP unit.

TABLE 1
Oxygen Mass balance

| Mass and energy | | | | |
|---|---|---|---|---|
| balance for a 5 MGD | Conventional | | Second | Third |
| plant | MBR | System 10 | System 30 | System 70 |
| Oxygen mass balance | | | | |
| (kg/d) | | | | |
| Nitrification | 2458 | 2458 | 2458 | 2458 |
| Credit for | −1218 | −1218 | −1218 | −1218 |
| denitrification | | | | |
| COD oxidation (kg/d) | 2430 | 1215 | 1215 | 1215 |
| Net oxygen demand | 3671 | 2456 | 2456 | 2456 |

TABLE 2
Sludge and electricity production

| Mass and energy balance | Conventional | System | Second | Third |
|---|---|---|---|---|
| for a 5 MGD plant | MBR | 10 | System 30 | System 70 |
| Mixed sludge to digester | 4185 | 4863 | 4863 | 4863 |
| (kg/d) | | | | |
| Digested sludge average | 2302 | 2675 | 2675 | 2675 |
| case (kg/d) | | | | |
| CHP electrical energy | 3375 | 3921 | 3921 | 3921 |
| kWh/d | | | | |

TABLE 3
Electrical energy demand for all unit processes

| Mass and energy balance | Conventional | System | Second | Third |
|---|---|---|---|---|
| for a 5 MGD plant | MBR | 10 | System 30 | System 70 |
| Electrical Energy | | | | |
| Consumption (kWh/d) | | | | |
| Preliminary and primary | −617 | −1306 | −1111 | −1111 |
| treatment | | | | |
| Reactor blowers | −1835 | −420 | −336 | −542 |
| Reactor mixing | −582 | −473 | −473 | −473 |
| Nitrate recycle | −411 | | −84 | −84 |
| Coagulant dosing for | −123 | −111 | −111 | −111 |
| phosphorous removal | | | | |
| Membrane filtration | −1742 | −1742 | | |
| system | | | | |
| Secondary clarifiers | | | −216 | −108 |
| WAS pump | −206 | 0 | −515 | 0 |
| RAS pumping | −1230 | −630 | −630 | −618 |
| Sludge (digester mixing, | −850 | −850 | −850 | −850 |
| centrifugation) | | | | |
| Total (kWh/d) | −7596 | −5532 | −4326 | −3897 |

TABLE 4
Flowsheet total electrical energy balance

| | | | Second | |
|---|---|---|---|---|
| Mass and energy balance | Conventional | | System | Third |
| for a 5 MGD plant | MBR | System 10 | 30 | System 70 |
| Electrical Energy | | | | |
| Consumption (kWh/d) | | | | |
| Total (kWh/d) | −7596 | −5532 | −4326 | −3897 |
| Electrical Energy | | | | |
| Production (kWh/d) | | | | |
| CHP electrical energy | 3375 | 3921 | 3921 | 3921 |
| (average case) | | | | |
| Total plant energy | | | | |
| balance (kWh/d) | | | | |
| Net electrical energy | (4221) | (1611) | (405) | 24 |
| (average case) | | | | |
| Specific energy (average | (0.223) | (0.085) | (0.021) | 0.001 |
| case) kWh/m³ | | | | |

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art.

What is claimed is:

1. A wastewater treatment system, comprising:
a first solid-liquid separation device;
a membrane aerated biofilm reactor;
a second solid-liquid separation device; and
an anaerobic digester,
wherein;
the membrane aerated biofilm reactor is downstream of the first solid-liquid separation unit,
the second solid-liquid separation unit is downstream of the membrane aerated biofilm reactor, and
sludge outlets from each of the first solid-liquid separation unit and the second solid-liquid separation unit are connected to the anaerobic digester.

2. The wastewater treatment system of claim 1, wherein the first solid-liquid separation device comprises a micro-sieve.

3. The wastewater treatment system of claim 1, further comprising an aeration tank upstream of the membrane aerated biofilm reactor.

4. The wastewater treatment system of claim 3, wherein the aeration tank is configured to operate with a solids retention time of 6 days or less.

5. The wastewater treatment system of claim 3, wherein the aeration tank is configured to operate with a hydraulic retention time of 6 hours or less.

6. The wastewater treatment system of claim 3, further comprising a sludge recycle line connected to the aeration tank or a point upstream of the aeration tank.

7. The wastewater treatment system of claim 3, wherein the first solid-liquid separation device is upstream of the aeration tank.

8. The wastewater treatment system of claim 7, further comprising a third solid-liquid separation device downstream of the aeration tank.

9. The wastewater treatment system of any of claim 3, further comprising an anoxic tank upstream of the aerobic tank.

10. The wastewater treatment system of claim 9, further comprising a recycle line from a downstream end of the membrane aerated biofilm reactor to the anoxic tank or a point upstream of the anoxic tank.

11. The wastewater treatment system of claim 1, further comprising a recycle line from a downstream end of the membrane aerated biofilm reactor to an upstream end of the membrane aerated biofilm reactor or a point upstream of the upstream end of the membrane aerated biofilm reactor.

12. The wastewater treatment system of claim 1, further comprising a sludge recycle line from the second solid-liquid separation device to the membrane aerated biofilm reactor or a point upstream of the membrane aerated biofilm reactor.

13. The wastewater treatment system of claim 1, wherein the second solid-liquid separation device comprises a membrane filtration unit.

14. The wastewater treatment system of any of claim 1, wherein the sludge outlet from the second solid-liquid separation unit is connected to the anaerobic digester via the first solid-liquid separation unit.

15. A wastewater treatment process, comprising steps of:
treating wastewater to produce a first sludge and a first effluent;
treating the first effluent with a membrane aerated biofilm so as to produce a second sludge and a second effluent; and
treating waste portions of the first sludge and the second sludge by way of anaerobic digestion,
wherein:
at least 50% of the total suspended solids and at least 40% of the chemical oxygen demand of the wastewater are removed to the anaerobic digester,
treating the wastewater comprises micro-sieving the wastewater, or
the wastewater treatment process further comprises aerating the wastewater for 6 hours or less.

16. The wastewater treatment process of claim 15, wherein treating the wastewater comprises micro-sieving the wastewater.

17. The wastewater treatment process of claim 15, further comprising solids contact aeration or contact stabilization.

18. The wastewater treatment process of claim 15, wherein treating the first effluent comprises solid-liquid separation to produce the second sludge and recycling a portion of the second sludge to a process tank containing the membrane aerated biofilm.

19. The wastewater treatment process of claim 18, wherein the solid-liquid separation comprises membrane filtration.

20. The wastewater treatment process of claim 15, further comprising of recycling the second effluent to an anoxic tank upstream of an aerobic tank.
